(19) United States
(12) Patent Application Publication
(10) Pub. No.: US 2007/0049452 A1
(43) Pub. Date: Mar. 1, 2007

(54) Common center section for independent rear suspension and fixed axle applications

(76) Inventor: Michael J. Carter, Troy, MI (US)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 11/217,005

(22) Filed: Aug. 31, 2005

(51) Int. Cl. F16H 48/06

(52) U.S. Cl. 475/220

(57) ABSTRACT

A drive system for a motor vehicle according to this invention includes a first housing that includes a first mounting surface for securing the first housing to one of an IRS housing and a beam housing. Located within the first housing and one of said IRS housing and the beam housing are a pinion, first and second drive shafts, a differential mechanism including an input for transmitting power differentially between first and second drive shafts and the pinion, and a ring gear meshing with the pinion and driveably connected to the differential mechanism.

### BACKGROUND OF THE INVENTION

The present invention relates generally to apparatus for fixed axle and independent rear suspension (IRS) applications in a motor vehicle. More particularly, the invention pertains to a center housing containing an inter-wheel differential mechanism, the center housing being adapted for use alternately with beam housing and IRS housing.

In fixed axle motor vehicle applications, a beam axle housing contains side shafts driven differentially from a driveshaft, which that driveably connects a transmission output to an inter-wheel differential mechanism. Alternatively, the vehicle may have an independent rear suspension, in which a differential case containing a differential mechanism drives right-side and left-side halfshafts that accommodate articulation and axial displacement of the drive wheels relative to the differential case. The halfshafts include a constant velocity joint, which transmits power between the differential and the drive wheels without restraining movement of the wheels relative to the suspension.

It is important that the components of such systems be light weight in order to maximize fuel economy especially in light duty trucks and sports utility vehicles. Maximum use of identical components for both fixed axle and IRS applications in rear drive systems is required.

### SUMMARY OF THE INVENTION

A drive system for a motor vehicle according to this invention includes a first housing that includes a first mounting surface for securing the first housing to one of an IRS housing and a beam housing. Located within the first housing and one of said IRS housing and the beam housing are a pinion, first and second drive shafts, a differential mechanism including an input for transmitting power differentially between first and second drive shafts and the pinion, and, a ring gear meshing with the pinion and driveably connected to the differential mechanism.

The first housing, sometimes called a center housing, can be secured to a light-weight stamped beam housing (also referred to as a banjo housing) or to a lightweight cast aluminum IRS housing, which is formed with mounts for IRS applications. A straddle mounted hypoid pinion and an integral hypoid ring gear help to minimize weight. The ring gear functions as a differential case cover, which eliminates an additional component and further help to reduce weight. The center housing has cast mounting bosses, which provide structural connections in IRS applications and can be used for clamp and locating devices during machining. The beam stamped housing can be formed with a cross section that is round, oval, or square, rectangular, or another suitable shape sufficient to support vehicle weight.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view showing a center housing and axle beam housing for fixed axle applications;

FIG. 2 is a perspective view showing a center housing and housing for independent rear suspension applications;

FIG. 3 is a partial cross section taken at a horizontal plane through the center housing and axle beam housing assembly of FIG. 1; and

FIG. 4 is a partial cross section taken at a horizontal plane through the center housing and IRS housing assembly of FIG. 2.

### DESCRIPTION OF THE PREFERRED EMBODIMENT

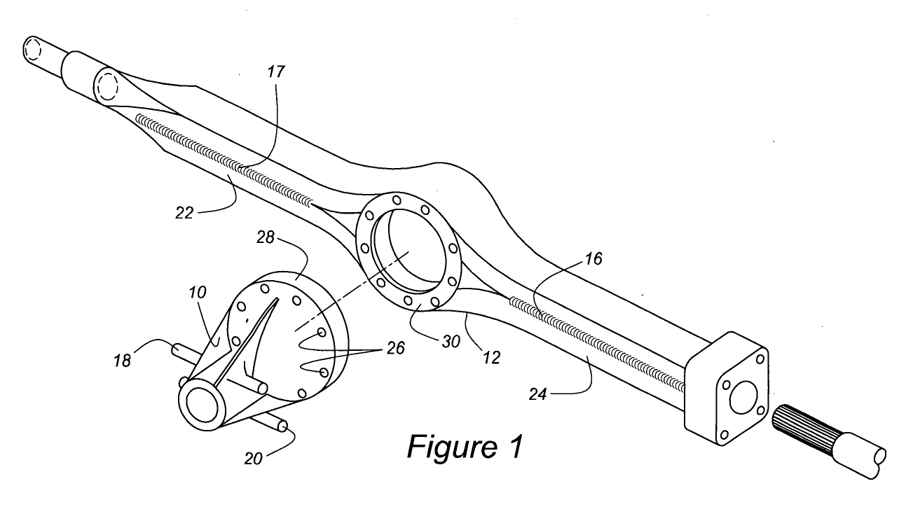

Referring first to FIG. 1, a center or first housing 10 and beam housing 12, when assembled together, enclose a space that contains a ring gear and its mating pinion, a differential mechanism, and shafts that transmit power between the drive wheels of a motor vehicle and the differential mechanism for vehicle applications in which the axle shafts are fixed in position within the beam housing 12.

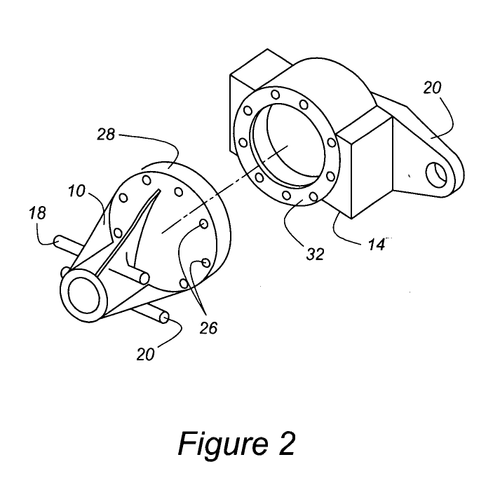

In FIG. 2, the center housing 10 is shown in position for assembly to an IRS housing 14. The center housing 10 and IRS housing 14 together provide an internal volume containing a ring gear and its mating pinion, a differential mechanism, and shafts that transmit power between the drive wheels of a motor vehicle and the differential mechanism for vehicle applications in which the axle shafts are supported for independent movement.

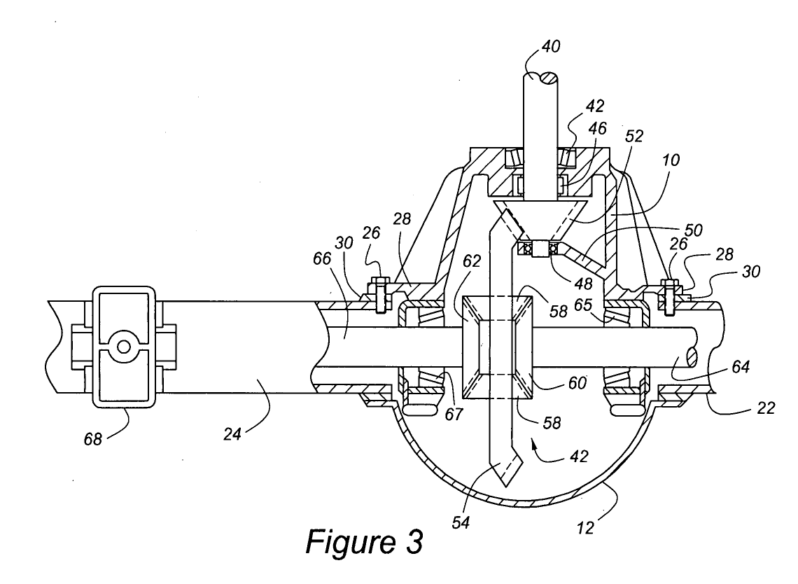

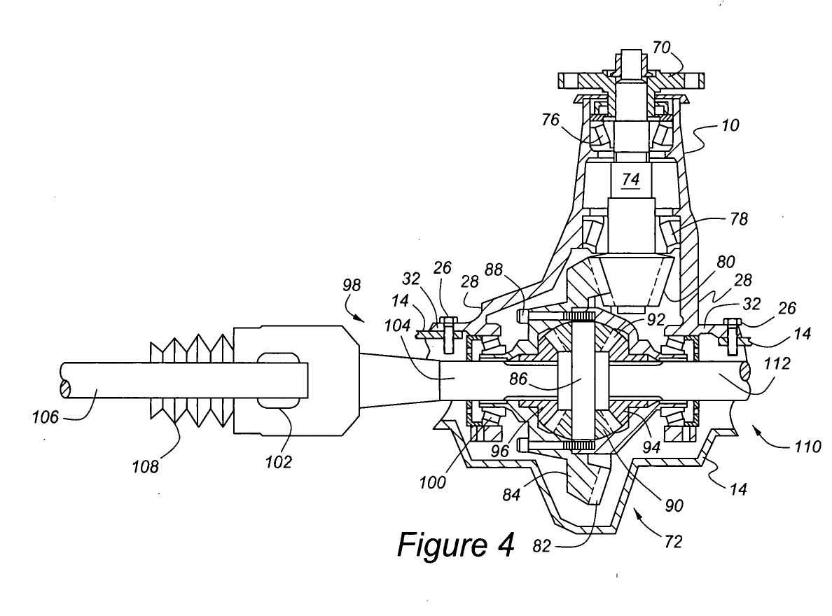

Housing 10 is substantially identical for either application, and the arrangement of components located within the assemblies of FIG. 1 and 2 may be either that illustrated in FIG. 3 or 4. Preferably housing 10 is a casting of aluminum or iron, housing 14 is an aluminum casting, and housing 12 is formed in sections of stamped or drawn steel, which are joined by welding along weld lines 16, 17.

Housing 10 is cast with several mounting bosses 18, 20 for use in the IRS applications. Beam housing 12 includes a beam arm 22 extending rightward from center housing 10, and a beam arm 24 extending leftward from the center housing 10. The laterally extending arms 22, 24 of the beam housing 12 have a cross section that is round, oval, square, or rectangular, as required to support the vehicle weight and operating loads.

Center housing 10 is secured by a series of bolt holes 26, located on a bolt circle and passing through a rearward-facing mounting flange 28, to the beam housing 12, which includes a forward-facing mounting flange 30 and bolt holes aligned with the bolt holes 26. Alternatively, housing 10 is secured by a series of holes 26, located on a bolt circle and passing through a rearward-facing mounting flange 28, to the IRS housing 14, which includes a forward-facing mounting flange 32 and bolt holes aligned with the bolt holes 26. In each case bolts, inserted in the aligned bolt holes, engage nuts or threads formed in the housing 12 or 14.

Turning now to FIG. 3, a rear driveshaft 40, which driveably connects a transmission output shaft to an inter-wheel differential mechanism 42, is supported on housing 10 by bearings 44. Driveshaft 40 is driveably secured to a bevel pinion 52, which is supported on housing 10 by pinion support bearings 46, 48. The rearward bearing 48 is straddle mounted on an arm 50, which extends radially toward the pinion shaft 44. Pinion 52, preferably a hypoid pinion, is in meshing engagement with a ring gear 54. Center bevel gears 58, secured to ring gear 54, are in continuous meshing engagement with a right-side bevel gear 60 and left-side bevel gear 62.

A right-hand axle shaft 64, secured to side bevel gear 60 and located in arm 22 of beam housing 12, extends rightward toward the right side drive wheel and is supported on housing 10 by a bearing 65. A left-hand axle shaft 66, secured to side bevel gear 62 and located in arm 24 of beam housing 12, extends leftward toward the left side drive wheel and is supported on housing 10 by a bearing 67. A mounting plate 68, secured to the outer surface of housing arm 24, provides support for a component of the vehicle suspension system.

In the embodiment illustrated in FIG. 4, the axle beam housing 12 is replaced by the IRS housing 14, and the rear-facing mounting flange 28 of the first housing 10 is secured to the front-facing mounting flange 32 of housing 14. A flange 70 secured to a rear driveshaft, driveably connects the transmission output to an inter-wheel differential mechanism 72 though a pinion shaft 74, which is rotatably supported on housing 10 by pinion shaft bearings 76, 78. The teeth of a hypoid pinion 80 mesh with the teeth 82 of a ring gear 84.

A differential shaft 86, secured by bolts 88 to the pinion 84, passes through center bevel pinions 90, 92 causing them to rotate as a unit with ring gear 84. Right-side bevel gear 94 and left-side bevel gear 96 mesh with center bevel gears 90, 92.

A left side differential output shaft or halfshaft 98, driveably connected to side bevel gear 92 and supported on housing 14 on bearings 100, extends leftward from the differential 72 toward the left-hand drive wheel (not shown). Halfshaft 98 includes a constant velocity joint 102, which articulates to accommodate movement of the left drive wheel relative to the differential 72 and may also displace axially to accommodate relative axial displacement. The constant velocity joint 102 transmits power between the inboard shaft component 104 of halfshaft 98 and the outboard shaft component 106. A boot 108 seals the constant velocity joint 102 against entry of dirt and other foreign matter.

Similarly a right-hand differential output shaft or halfshaft 110, driveably connected to side bevel gear 94, extends rightward from the differential 72 toward the right drive wheel (not shown). Halfshaft 110 also includes a constant velocity joint, which articulates to accommodate movement of the right drive wheel relative to the differential 72 and may also displace axially to accommodate relative axial displacement. The constant velocity joint and halfshaft 110 transmit power between the inboard shaft component 112 of halfshaft 110 and an outboard shaft component (not shown).

In accordance with the provisions of the patent statutes, the present invention has been described in what is considered to represent its preferred embodiment. However, it should be noted that the invention can be practiced otherwise than as specifically illustrated and described without departing from its spirit or scope.

What is claimed is:

1. A drive system for a motor vehicle comprising:
a rear drive shaft;
a first housing including a first mounting surface for securing the first housing alternately to one of an IRS housing and a beam housing, the first housing and one of said IRS housing and said beam housing together defining a space wherein the following components are located:
a pinion driveably connected to the rear drive shaft;
first and second drive shafts;
a differential mechanism including for transmitting power differentially between the pinion and the first and second drive shafts; and
a ring gear meshing with the pinion and driveably connected to the differential mechanism.

2. The drive system of claim 1 wherein the first housing further includes bosses extending from an outer surface thereof.

3. The drive system of claim 1 wherein the first housing further includes:
flange for a straddle arm located within said space, extending toward the pinion; and
a bearing located on the arm and aligned with an axis about which the pinion rotates for supporting the pinion in rotation about said axis.

4. The drive system of claim 1 wherein the beam housing further includes:
a second mounting surface contacting the first mounting surface, for securing the beam housing to the first mounting surface of the first housing;
a first arm extending laterally away from the differential mechanism, the first drive shaft being located in and extending along the first arm; and
a second arm extending away from the differential mechanism in a lateral direction substantially opposite that of the first arm, the second drive shaft being located in and extending along the second arm.

5. The drive system of claim 1 wherein the IRS housing is formed with a first opening and second opening, the IRS housing further comprising:
a third mounting surface contacting the first mounting surface, for securing the IRS housing to the first mounting surface of the first housing; and wherein
a first drive shaft extends from said space through the first opening laterally away from the differential mechanism; and the second drive shaft extends from said space through the second opening in a lateral direction substantially opposite that of the first drive shaft.

6. The drive system of claim 1 wherein the first drive shaft is a halfshaft that includes a constant velocity joint, and the second drive shaft is a halfshaft that includes a constant velocity joint.

7. A drive assembly for a motor vehicle comprising:
a first housing including a first mounting surface formed with a series of bolt holes for securing the first housing to one of an IRS housing and a beam housing, the beam housing including a second mounting surface able to contact the first mounting surface and formed with a second series of bolt holes, each hole being aligned with a hole of the first mounting surface, the IRS housing including a third mounting able to contact the first mounting surface and formed with third series of bolt holes, each hole being aligned with a hole of the first mounting surface, for securing the beam housing to the first mounting surface of the first housing, the first housing and one of said IRS housing and the beam housing together defining a space therein,
the drive assembly further including a pinion, first and second drive shafts, a differential mechanism including an input for transmitting power differentially between first and second drive shafts and the pinion, and a ring gear meshing with the pinion and driveably connected to the differential mechanism.

8. The drive system of claim 7 wherein the first housing further includes bosses extending from an outer surface thereof.

9. The drive system of claim 7 wherein the first housing further includes:
flange for a straddle arm located within said space, extending toward the pinion; and
a bearing located on the arm and aligned with an axis about which the pinion rotates for supporting the pinion in rotation about said axis.

10. The drive system of claim 7 wherein the beam housing further includes:
a second mounting surface contacting the first mounting surface, for securing the beam housing to the first mounting surface of the first housing;
a first arm extending laterally away from the differential mechanism, the first drive shaft being located in and extending along the first arm; and
a second arm extending away from the differential mechanism in a lateral direction substantially opposite that of the first arm, the second drive shaft being located in and extending along the second arm.

11. The drive system of claim 7 wherein the IRS housing is formed with a first opening and second opening, the IRS housing further comprising:
a third mounting surface contacting the first mounting surface, for securing the IRS housing to the first mounting surface of the first housing; and wherein
a first drive shaft extends from said space through the first opening laterally away from the differential mechanism; and the second drive shaft extends from said space through the second opening in a lateral direction substantially opposite that of the first drive shaft.

12. The drive system of claim 7 wherein the first drive shaft is a halfshaft that includes a constant velocity joint, and the second drive shaft is a halfshaft that includes a constant velocity joint.
